(19) United States
(12) Patent Application Publication
(10) Pub. No.: US 2021/0040357 A1
(43) Pub. Date: Feb. 11, 2021

(54) ELECTROCONDUCTIVE ADHESIVE COMPOSITION, CURED PRODUCT OF ELECTROCONDUCTIVE ADHESIVE, AND ELECTRONIC DEVICE

(71) Applicant: TANAKA KIKINZOKU KOGYO K.K., Tokyo (JP)

(72) Inventors: Takeshi KONDO, Kanagawa (JP); Rikia FURUSHO, Kanagawa (JP); Shintaroh ABE, Kanagawa (JP)

(73) Assignee: TANAKA KIKINZOKU KOGYO K.K., Tokyo (JP)

(21) Appl. No.: 16/963,922

(22) PCT Filed: Jan. 22, 2019
(86) PCT No.: PCT/JP2019/001884

§ 371 Date: Jul. 22, 2020

(30) Foreign Application Priority Data
Jan. 23, 2018 (JP) 2018-009115

(51) Int. Cl. C09J 9/02; C09J 163/00

(52) U.S. Cl. CPC C09J 9/02; C08K 2003/0806; C09J 163/00

(57) ABSTRACT

The purpose of the present invention is to provide an electroconductive adhesive composition that does not readily peel from an adherend material even when subjected to repeated temperature changes, and that furthermore has excellent thermal conductivity. The present invention relates to an electroconductive adhesive composition containing an organic acid (A) having an acid dissociation constant pKa of 4.8 or lower and an electroconductive filler (B), the electroconductive adhesive composition containing 0.01-0.2% by mass of the organic acid (A) and at least 85% by mass of the electroconductive filler (B) with respect to the entire quantity of the electroconductive adhesive composition.

### TECHNICAL FIELD

The present invention relates to an electrically conductive adhesive composition, a cured product of the electrically conductive adhesive composition, and an electronic device using the electrically conductive adhesive composition.

### BACKGROUND ART

In the bonding of various members, such as die bonding to a support member of a semiconductor device, instead of bonding with conventionally widely used brazing materials or solders, attention has recently been focused on bonding with an electrically conductive adhesive composition containing a filler composed of an electrically conductive metal from the viewpoint of electrical conductivity, thermal conductivity, etc.

For example, Patent Literature 1 has reported an electrically conductive paste for die bonding, including a metal powder and an organic solvent, wherein the metal powder is composed of one or more metal particles selected from a silver powder, a palladium powder and a copper powder, each having a purity of 99.9 mass % or more and an average particle diameter of 0.01 to 1.0 μm, and a coating layer composed of gold covering at least part of the metal particle.

In addition, Patent Literature 2 has reported an electrically conductive adhesive including a plurality of solid electrically conductive particles containing at least any of gold, silver, copper, platinum, palladium, rhodium, nickel, iron, cobalt, tin, indium, aluminum, zinc, and a compound or alloy thereof, each having an average particle diameter of 0.1 to 100 μm, a solid lubricative particle which is not metal-bonded to the solid electrically conductive particle and has higher lubricity than the solid electrically conductive particle, and water or an organic solvent.

### CITATION LIST

### Patent Literature

Patent Literature 1: JP-A-2013-206765 (the term “JP-A” as used herein means an “unexamined published Japanese patent application”)

Patent Literature 2: JP-A-2010-267579

### SUMMARY OF INVENTION

### Technical Problem

in an electronic component, a semiconductor element generates heat by energization at the time of usage. In order to efficiently dissipate the heat and prevent damage to the semiconductor element, high thermal conductivity is required of a die bonding material.

In addition, a die bonding material is subjected to repeated temperature change due to the above-described heat generation and in turn, the adhesion by the die bonding material deteriorates, as a result, the semiconductor element may be separated from the support member.

With the intent to enhance the thermal conductivity of an electrically conductive adhesive composition, which is one of the purposes, it is practiced to increase the content rate of a metal component in the electrically conductive adhesive composition and thereby raise the packing density of the obtained adhesive layer (a cured product of the electrically conductive adhesive composition). However, an adhesive layer having a high packing density generally shows low stress relaxation performance and therefore, tends to be susceptible particularly to separation due to the above-described repeated temperature change. For this reason, it has been difficult to achieve both prevention of separation due to repeated temperature change and excellent thermal conductivity.

The present invention has been invented in consideration of these problems and an object thereof is to provide an electrically conductive adhesive composition which is less likely to cause adherend separation even when subjected to repeated temperature change and moreover, has excellent thermal conductivity.

### Solution to Problem

As a result of intensive studies, the present inventors have found that in an electrically conductive adhesive composition, when the content of an electrically conductive filler is set to fall within a predetermined range and furthermore, a predetermined amount of an organic acid having an acid dissociation constant pKa of 4.8 or less is contained, the above-described object can be attained. The present invention has been accomplished based on this finding.

More specifically, an electrically conductive adhesive composition of the present invention is an electrically conductive adhesive composition including an organic acid (A) and an electrically conductive filler (B), wherein the electrically conductive adhesive composition contains from 0.01 to 0.2 mass % of the organic acid (A) and 85 mass % or more of the electrically conductive filler (B), relative to the overall amount of the electrically conductive adhesive composition, and the organic acid (A) has an acid dissociation constant pKa of 4.8 or less.

In an electrically conductive adhesive composition according to one embodiment of the present invention, the organic acid (A) has a molecular weight of 170 or more.

In an electrically conductive adhesive composition according to one embodiment of the present invention, the organic acid (A) is at least one organic acid selected from the group consisting of abietic acid, pimaric acid, isopimaric acid, palustric acid, dehydroabietic acid, neoabietic acid, sebacic acid, ascorbic acid, and suberic acid.

In an electrically conductive adhesive composition according to one embodiment of the present invention, the electrically conductive adhesive composition contains a binder resin (C1) and may further contain at least one selected from the group consisting of a diluent (C2), a curing agent (C3), and a curing accelerator (C4), and denoting [B] mass % as the content of the electrically conductive filler (B) and denoting [C] mass % as the sum of the contents of the binder resin (C1), the diluent (C2), the curing agent (C3) and the curing accelerator (C4), [B]/[C] is 95/5 or more.

A cured electrically conductive adhesive of the present invention is obtained by curing the electrically conductive adhesive composition of the present invention.

In an electronic device of the present invention, the electrically conductive adhesive composition of the present invention is used for the adhesion of a component.

### Advantageous Effects of Invention

The electrically conductive adhesive composition of the present invention is characterized by containing a predetermined amount of an electrically conductive filler and further containing a predetermined amount of an organic acid having an acid dissociation constant pKa of 4.8 or less, and thanks to this configuration, the electrically conductive adhesive composition is less likely to cause adherend separation even when subjected to repeated temperature change and moreover, has excellent thermal conductivity.

### DESCRIPTION OF EMBODIMENTS

Embodiments for implementing the present invention are described below, but the present invention is not limited to the following embodiments and can be implemented by making any modification without departing from the gist of the present invention. In the present description, the word “to” indicating a numerical range is used in the sense that the numerical values described before and after the word are included as the lower limit value and the upper limit value.

### [Organic Acid (A)]

The electrically conductive adhesive composition of the present invention contains from 0.01 to 0.2 mass % of an organic acid (A) having an acid dissociation constant pKa of 4.8 or less, relative to the overall amount of the electrically conductive adhesive composition.

In the present invention, as the organic acid (A), a single acid may be used, or two or more acids may be used.

In general, the surface of an electrically conductive filler is coated with an organic fatty acid (coating agent) having pKa of about 5.0, such as stearic acid or oleic acid, but the pKa of the organic acid (A) used in the present invention is 4.8 or less and is low compared with the acid above. As the pKa of an acid is lower, the acid is more readily adsorbed on the electrically conductive filler surface by an electrostatic action, and consequently, the electrically conductive filler in the present invention is put into a state of being firmly coated with the organic acid (A) in place of the original coating agent.

Although resintering of the electrically conductive filler is mentioned as one of causes that are responsible for the adherend separation due to the repeated temperature change, the electrically conductive filler in the present invention is firmly coated with the organic acid (A), and the resintering is therefore inhibited. In turn, the electrically conductive adhesive composition of the present invention hardly causes separation due to the repeated temperature change.

In order to obtain this effect, pKa of the organic acid (A) may be 4.8 or less but is preferably 4.7 or less, more preferably 4.6 or less.

The lower limit of the acid dissociation constant pKa of the organic acid (A) is not particularly limited, but an organic acid having a low pKa holds the possibility of forming an organic salt with a metal to thicken the electrically conductive adhesive composition. Accordingly, pKa of the organic acid (A) is preferably 4.3 or more, more preferably 4.4 or more, still more preferably 4.5 or more.

In the case where the organic acid (A) has a plurality of acid dissociation constants pKa, at least one of the plurality of acid dissociation constants pKa may be 4.8 or less.

Incidentally, in the case of using two or more kinds of acids as the organic acid (A), it may be sufficient as long as at least one of them has an acid dissociation constant of 4.8 or less.

In the present invention, the organic acid (A) is contained in an amount of 0.01 to 0.2 mass % relative to the overall amount of the electrically conductive adhesive composition.

The organic acid (A) is a component contributing to suppressing the separation due to repeated temperature change, but if its content is excessive, probably because at the time of curing, the component inhibits sintering between electrically conductive fillers or sintering between an electrically conductive filler and an adherend material to make the bonding state poor, separation due to repeated temperature change rather is likely to occur. On the other hand, if the content is too small, the effect of suppressing separation is not obtained.

From this viewpoint, the content of the organic acid (A) is 0.01 mass % or more, preferably 0.03 mass % or more, more preferably 0.05 mass % or more. In addition, the content of the organic acid (A) is 0.2 mass % or less, preferably 0.15 mass % or less, more preferably 0.1 mass % or less.

In the present invention, if the molecular weight of the organic acid (A) is too small, the electrically conductive adhesive composition may undergo evaporation or thermal decomposition during its curing. Accordingly, the molecular weight of the organic acid (A) is preferably 170 or more, more preferably 185 or more, still more preferably 200 or more.

Furthermore, in order to facilitate paste formation, the molecular weight of the organic acid (A) is preferably 500 or less, more preferably 400 or less, still more preferably 350 or less.

Incidentally, in the case of using two or more kinds of acids as the organic acid (A), it is preferred that the molecular weight of at least one kind of an acid is 170 or more.

In addition, although it is not particularly limited, the organic acid (A) in the present invention is preferably at least one organic acid selected from the group consisting of abietic acid, pimaric acid, isopimaric acid, palustric acid, dehydroabietic acid, neoabietic acid, sebacic acid, ascorbic acid, and suberic acid.

### [Electrically Conductive Filler (B)]

The electrically conductive filler (B) in the present invention is not particularly limited as long as it is a component contributing to electrical conductivity of the electrically conductive adhesive composition, but a metal, a carbon nanotube, etc. are preferred. As the metal, all metal powders treated in general as a conductor can be used. Examples thereof include elemental metals such as silver, copper, gold, nickel, aluminum, chromium, platinum, palladium, tungsten and molybdenum, alloys composed of two or more of these metals, articles coated with these metals, oxides of these metals, and good electrical conductivity-carrying compounds of these metals. Among these, metals including silver or copper as a main component are preferred because of their insusceptibility to oxidation and high thermal conductivity, and metals including silver as a main component are more preferred because of their excellent electrical conductivity and oxidation resistance. The “main component” as used herein means a component of which content is largest out of the components in the electrically conductive particle.

As for the electrically conductive filler (B) in the present invention, a single electrically conductive filler may be used, or two or more kinds of electrically conductive fillers may be used.

In the electrically conductive adhesive composition of the present invention, if the content of the electrically conductive filler (B) is small, good thermal conductivity cannot be secured. Accordingly, in the present invention, the content of the electrically conductive filler (B) is 85 mass % or more relative to the overall amount of the electrically conductive adhesive composition.

Furthermore, in order to obtain good thermal conductivity, the content of the electrically conductive filler (B) is preferably 91 mass % or more relative to the overall amount of the electrically conductive adhesive composition.

In the present invention, the upper limit of the content of the electrically conductive filler (B) is not particularly limited, but if the content of the electrically conductive filler is increased, this may make the paste formation difficult. For this reason, in the present invention, the content of the electrically conductive filler (B) is preferably 96 mass % or less, more preferably 93 mass % or less.

The average particle diameter (d50) of the electrically conductive filler (B) is not particularly limited, but in view of, for example, cost at the time of micronization of the electrically conductive filler (B), ease of paste formation, and assuring of adhesiveness to an adherend material, it is preferably from 0.05 to 20 μm, more preferably from 0.08 to 10 μm, still more preferably from 0.1 to 6 μm.

Incidentally, the average particle diameter of the electrically conductive filler (B) is the 50% average particle diameter (d50) in a particle diameter distribution measured using a laser diffraction/scattering particle size analyzer. For example, the average particle diameter can be measured using a laser diffraction/scattering particle size analyzer, MT-3000, manufactured by Nikkiso Co., Ltd.

In addition, a plurality of electrically conductive fillers differing in the average particle diameter can also be used, and in order to obtain excellent electrical conductivity or thermal conductivity, it is preferable to use a mixture of an electrically conductive filler having an average particle diameter on the micrometer order and an electrically conductive filler having an average particle diameter on the nanometer order.

In this case, from the viewpoint of, for example, decreasing the amount of the solvent or reducing the shrinkage rate after curing, the average particle diameter of the micrometer-order electrically conductive filler is preferably 0.7 μm or more, more preferably 1 μm or more, still more preferably 1.5 μm or more, and is preferably 20 μm or less, more preferably 10 μm or less, still more preferably 6 μm or less.

In addition, from the viewpoint of, for example, enhancing the electrical conductivity or improving the bonding reliability, the particle diameter of the nanometer-order electrically conductive filler is preferably 50 nm or more, more preferably 70 nm or more, still more preferably 100 nm or more, and is preferably 300 nm or less, more preferably 200 nm or less, still more preferably 150 nm or less.

Furthermore, in the case of using a mixture of a micrometer-order electrically conductive filler and a nanometer-order electrically conductive filler, in view of electrical conductivity, bonding reliability, etc., the ratio of the contents of the micrometer-order electrically conductive filler and the nanometer-order electrically conductive filler in the electrically conductive adhesive composition is, in terms of mass ratio, preferably from 90/10 to 50/50, more preferably from 80/20 to 60/40, still more preferably from 75/25 to 65/35.

The tap density of the electrically conductive filler (B) is not particularly limited but in order to ensure the adhesive strength to an adherend, is preferably 4 g % cm³ or more, more preferably 5 g/cm³ or more, still more preferably 5.5 g/cm³ or more. Furthermore, in order to prevent the electrically conductive filler (B) from settling and becoming unstable during long-term storage of the electrically conductive adhesive composition, the tap density is preferably 8 g/cm³ or less, more preferably 7.5 g/cm³ or less, still more preferably 7.0 g/cm³ or less. The tap density is measured and calculated, for example, by Metallic powders-Determination of tap density of JIS Z2512:2012.

The specific surface area of the electrically conductive filler (B) is not particularly limited but is preferably from 0.1 to 3 m²/g, more preferably from 0.2 to 2 m²/g, still more preferably from 0.3 to 1 m²/g. When the specific surface area of the electrically conductive filler (B) is 0.1 m²/g or more, the surface area of the electrically conductive filler (B), which comes into contact with an adherend, can be ensured. In addition, when the specific surface area of the electrically conductive filler (B) is 3 m²/g or less, the amount of a solvent contained in the electrically conductive adhesive composition can be reduced.

The shape of the electrically conductive filler (B) is not particularly limited and includes, for example, powdery, spherical, flaky, foil-like, plate-like and dendritic shapes. In general, a flaky shape or a spherical shape is selected. Furthermore, other than single metal particles, a metal particle surface-coated with another metal, or a mixture of a plurality of kinds of metal particles, can be used.

The surface of the electrically conductive filler (B) may be coated with a coating agent. When the filler (B) is coated with a coating agent, the dispersibility with a binder resin such as epoxy resin is enhanced, and this makes paste formation easy. The coating agent includes, for example, a coating agent containing a carboxylic acid. By using a coating agent containing a carboxylic acid, the heat dissipation property of the electrically conductive adhesive composition can be further enhanced.

As the coating agent, an acid having pKa of about 5.0 and a molecular weight of about 280 is generally used, and specifically, stearic acid, oleic acid, etc. is used as described above.

The method for coating the surface of the electrically conductive filler (B) with a coating agent includes known methods, for example, a method in which both the filler and the coating agent are stirred and kneaded together in a mixer, and a method in which the electrically conductive filler (B) is impregnated with a solution of a carboxylic acid and the solvent is volatilized.

### [Binder Resin (C1), Diluent (C2), Curing Agent (C3), Curing Accelerator (C4)]

The electrically conductive adhesive composition of the present invention may contain a binder resin (C1), a diluent (C2), a curing agent (C3), and a curing accelerator (C4), in addition to the organic acid (A) and the electrically conductive filler (B).

In the case of incorporating any of (C1) to (C4) into the electrically conductive adhesive composition of the present invention, denoting [B] mass % as the content of the electrically conductive filler (B) and denoting [C] mass % as the sum of the contents of the binder resin (C1), the diluent (C2), the curing agent (C3) and the curing accelerator (C4), [B]/[C] is preferably set to be 95/5 or more, because good thermal conductivity can be obtained. [B]/[C] is more preferably 96/4 or more, still more preferably 97/3 or more.

The binder resin (C1), the diluent (C2), the curing agent (C3) and the curing accelerator (C4) are described below.

### <Binder Resin (C1)>

The electrically conductive adhesive composition of the present invention can contain a binder resin (C1) for dispersing the organic acid (A) and the electrically conductive filler (B). The binder resin is not particularly limited, but, for example, an epoxy resin, a phenol resin, a urethane resin, an acrylic resin, a silicone resin, or a polyimide resin, etc. may be used, and one of these may be used alone, or a plurality of kinds thereof may be used in combination. In view of operation efficiency, the binder resin in the present invention is preferably a thermosetting resin, more preferably an epoxy resin.

In the case of incorporating the binder resin (C1) into the electrically conductive adhesive composition of the present invention, the content thereof is preferably 0.4 mass % or more relative to the overall amount of the electrically conductive adhesive composition, because stable adhesive strength can be obtained. The content is more preferably 0.8 mass % or more, still more preferably 1.0 mass % or more. On the other hand, in order to ensure thermal conductivity, the content of the binder resin is preferably 5.0 mass % or less, more preferably 3.0 mass % or less, still more preferably 2.0 mass % or less, relative to the overall amount of the electrically conductive adhesive composition.

### <Diluent (C2)>

In the case where the electrically conductive adhesive composition of the present invention contains the binder resin (C1), the composition may further contain a diluent (C2) for diluting the binder resin (C1). The diluent is not particularly limited, but it is preferable to use, for example, a reactive diluent such as 1,4 butanediol diglycidyl ether and neopentyl diglycidyl ether. As for the diluent (C2), only one kind of a diluent may be used, or two or more kinds of diluents may be used in combination.

in the case of incorporating the diluent (C2) into the electrically conductive adhesive composition of the present invention, the content thereof is preferably from 0.1 to 5 mass % relative to the overall amount of the electrically conductive adhesive composition, because the viscosity of the electrically conductive adhesive composition falls within a favorable range.

### <Curing Agent (C3)>

Furthermore, in the case where the electrically conductive adhesive composition of the present invention contains the binder resin (C1), the composition may contain a curing agent (C3) for curing the binder resin (C1). The curing agent (C3) includes, for example, an amine-based curing agent such as tertiary amine, alkyl urea and imidazole, and a phenolic curing agent, etc. As for the curing agent (C3), only one kind of a curing agent may be used, or two or more kinds of curing agents may be used in combination.

In the case of incorporating the curing agent (C3) into the electrically conductive adhesive composition of the present invention, the content thereof is preferably 1.0 mass % or less relative to the overall amount of the electrically conductive adhesive composition, because the curing agent is less likely to remain uncured and the adhesiveness to an adherend material is improved.

### <Curing Accelerator (C4)>

In the case where the electrically conductive adhesive composition of the present invention contains the binder resin (C1), the composition may contain a curing accelerator (C4) for accelerating the curing of the binder resin (C1). The curing accelerator (C4) includes, for example, imidazoles such as 2-phenyl-4,5-dihydroxymethylimidazole, 2-phenyl-4-methyl-5-hydroxymethylimidazole, 2-methyl-4-methylimidazole and 1-cyano-2-ethyl-4-methylimidazole, tertiary amines, triphenylphosphines, urea compounds, phenols, alcohols, and carboxylic acids, etc. As for the curing accelerator (C4), only one kind of a curing accelerator may be used, or two or more kinds of curing accelerators may be used in combination.

In the case of incorporating the curing accelerator (C4) into the electrically conductive adhesive composition of the present invention, the content thereof is not particularly limited and may be appropriately determined, but in general, the content is 0.5 mass % or less relative to the overall amount of the electrically conductive adhesive composition.

### [Other Components]

As long as the effects of the present invention are not impaired, other components may be appropriately incorporated into the electrically conductive adhesive composition of the present invention. Other components include, for example, a solvent.

### <Solvent>

Incorporation of a solvent into the electrically conductive adhesive composition of the present invention facilitates paste formation. The solvent is not particularly limited, but in order for the solvent to be readily volatilized at the time of curing of the electrically conductive adhesive composition, a solvent having a boiling point of 350° C. or less is preferred, and a solvent having a boiling point of 300° C. or less is more preferred. Specifically, the solvent includes an acetate, an ether, a hydrocarbon, etc., and more specifically, dibutyl carbitol, butyl carbitol acetate, etc. are preferably used.

The content rate of the solvent is usually 15 mass % or less relative to the electrically conductive adhesive composition, and in view of operation efficiency, the content rate is preferably 10 mass % or less.

Other than the solvent, as long as the effects of the present invention are not impaired, an antioxidant, an ultraviolet absorber, a tackifier, a viscosity regulator, a dispersant, a coupling agent, a toughening agent, an elastomer, etc. can be appropriately incorporated into the electrically conductive adhesive composition of the present invention.

The electrically conductive adhesive composition of the present invention can be obtained by mixing and stirring, in an arbitrary order, the above-described (A) and (B) and, as optional components, (C1) to (C4) and other components. As the dispersion method, for example, systems such as two-roll, three-roll, sand mill, roll mill, ball mill, colloid mill, jet mill, bead mill, kneader, homogenizer and propellerless mixer can be employed.

In addition, the cured electrically conductive adhesive of the present invention is obtained by curing the electrically conductive adhesive composition of the present invention. The curing method is not particularly limited, but the cured electrically adhesive can be obtained, for example, by heat-treating the electrically conductive adhesive composition at 100 to 250° C. for 0.5 to 3 hours.

In order to ensure the heat dissipation property of an adherend material, the thermal conductivity of the cured electrically conductive adhesive of the present invention is preferably 5 W/m·K or more, more preferably 10 W/m·K or more, still more preferably 20 W/m·K or more. Here, the thermal conductivity of the cured electrically conductive adhesive can be calculated using the method described in the paragraph of Examples.

Furthermore, in the case where adhesion is performed using the electrically conductive adhesive composition of the present invention, the adhesion is usually effected by curing the electrically conductive adhesive composition under heating. At this time, the heating temperature is not particularly limited, but in order to form a close-contact state between the electrically conductive fillers (B) and between an adherend material and the electrically conductive filler (B), in which the fillers or the filler and adherend material are brought into point contact with each other, and thereby stabilize the shape as an adhesion part, the temperature is preferably 100° C. or more, more preferably 130° C. or more, still more preferably 150° C. or more.

In addition, for the purpose of avoiding that mutual bonding of the electrically conductive fillers (B) excessively proceeds and necking occurs between the electrically conductive fillers (B) to firmly bond the fillers to each other and produce an excessively hardened state, the temperature during curing is preferably 250° C. or less, more preferably 230° C. or less, still more preferably 210° C. or less.

The method for evaluating the fact that in the case of using the electrically conductive adhesive composition of the present invention for the adhesion to an adherend, separation of the adherend material is less likely to occur even when subjected to repeated temperature change, includes various methods but includes, for example, a method in which a thermal cycle test is conducted by the method described later in Examples and the ratio of peeled area after the test is measured by the method described later in Examples. The ratio of peeled area measured by this method is preferably 20% or less, more preferably 15% or less, still more preferably 10% or less.

The electrically conductive adhesive composition of the present invention can be used for the adhesion of a component in an electronic device.

### Examples

The present invention is described more specifically below by referring to Examples, however, the present invention is not limited by these Examples in any way.

### A. Preparation of Electrically Conductive Adhesive Composition

The materials shown in Table 1 were kneaded in a three-roll mill to prepare an electrically conductive adhesive composition having a composition shown in Table 1 (the numerical value for each material in Table 1 indicates the content (mass %) relative to the total mass of the electrically conductive adhesive composition). The materials used are as follows. The order of kneading was (C1) to (C4), (A), (B), and a solvent.

### [Organic Acid (A)]

Abietic acid:

Acid dissociation constant pKa: 4.64, molecular weight: 302.44, melting point: 139° C.

Sebacic acid:

Acid dissociation constant pKa: 4.72, molecular weight: 202.25, melting point: 131° C.

Ascorbic acid:

Acid dissociation constant pKa: 4.17, molecular weight: 176.12, melting point: 190° C.

### [Other Organic Acids]

Stearic acid:

Acid dissociation constant pKa: 5, molecular weight: 284.48, melting point: 69.6° C.

### [Electrically Conductive Filler (B)]

Silver particle 1:

Flaky, average particle diameter d50: 4 μm, tap density: 6.7 g/cm³, produced by Tanaka Kikinzoku Kogyo K.K.

Silver particle 2:

Spherical, average particle diameter d50: 0.8 μm, tap density: 5.5 g/cm³, produced by Tanaka Kikinzoku Kogyo K.K.

Silver particle 3:

Spherical, average particle diameter d50: 50 nm

Silver-coated copper particle:

Flaky, average particle diameter d50: 6 μm, silver content: 20 mass %, produced by Metalor

### [Binder Resin (C1), Diluent (C2), Curing Agent (C3), Curing Accelerator (C4)]

Binder resin 1:

Phenol novolac type (“EPALLOY (registered trademark) 8330” (trade name), produced by Emerald Performance Materials, liquid at room temperature, epoxy equivalent: 177 g/eq

Binder resin 2:

“EPICLON (registered trademark) 830-S” (trade name), produced by Dainippon Ink & Chemicals, Inc., liquid at room temperature, epoxy equivalent: 169 g/eq

Binder resin 3:

“ADEKA RESIN (registered trademark) EP-3950L” (trade name), produced by ADEKA Corporation, liquid at room temperature, epoxy equivalent: 95 g/eq

Diluent:

Difunctional reactive diluent (Adeka Glycirol (registered trademark) ED-523L, produced by ADEKA Corporation)

Curing agent:

Phenolic curing agent (MEH8000H, produced by Meiwa Plastic Industries, Ltd.)

Curing accelerator:

2-Phenyl-4,5-dihydroxymethylimidazole (2PHZ)

### [Other Components]

Solvent:

Butyl carbitol acetate (produced by Tokyo Kasei Kogyo Co., Ltd.)

### B. Evaluation of Physical Properties

### (Thermal Conductivity)

A silver-plated copper lead frame of 10 mm×10 mm was coated with the electrically conductive adhesive composition obtained and after placing a silver-sputtered silicon chip of mm×5 mm on the coated surface, heated at 250° C. for 60 minutes in a nitrogen atmosphere to prepare a bonded body in which the silver-plated copper lead frame and the silver-sputtered silicon chip are bonded via a cured electrically conductive adhesive (hereinafter, sometimes simply referred to as “bonded body”).

The thermal conductivity of the bonded body obtained is shown in Table 1.

Incidentally, the thermal conductivity λ (W/m·K) was calculated according to the relational expression λ=a×d×Cp by using the thermal diffusion a measured by means of a laser flash method thermal constant measurement system (“TC-7000” (trade name), manufactured by ULVAC-RIKO, Inc.) in conformity with ASTM-E1461, the room-temperature specific gravity d computed by the pycnometer method, and the room-temperature specific heat Cp measured by means of a differential scanning calorimeter (“DSC7020” (trade name), manufactured by Seiko Instruments & Electronics Ltd.) in conformity with JS-K7123:2012.

### (Peeled Area)

Furthermore, a thermal cycle test was performed using the bonded body obtained, and the peeled area was measured. In this test, an operation of holding the substrate at −50° C. for 30 minutes and then holding at 150° C. for 30 minutes was taken as one cycle, and by repeating 2,000 cycles, the ratio of the peeled area of the silicon chip after the test was measured. The results are shown in Table 1.

Incidentally, the ratio of the peeled area was determined according to the following relational expression by subjecting an image of the peeled state after 2,000 cycles, which was obtained using an ultrasonic imaging/inspection device “Fine SAT” (trade name), to an image conversion from light/shade into two gradations of white and black by means of a binariation software “image J.

Ratio of peeled area (%)=peeled area (number of black pixels)÷chip area (number of black pixels+number of white pixels)×100

### (Room-Temperature Bonding Strength)

A silver-plated copper lead frame of 10 mm×10 mm was coated with the electrically conductive adhesive composition obtained and after placing a silver-sputtered silicon chip of 2 mm×2 mm on the coated surface, heated at 250° C. for 60 minutes in a nitrogen atmosphere to prepare a bonded body in which the silver-plated copper lead frame and the silver-sputtered silicon chip are bonded via a cured electrically conductive adhesive (hereinafter, sometimes simply referred to as “bonded body”). The resulting bonded body was subjected to a breaking test at room temperature using Bond Tester 4000 manufactured by Nordson Advance Technology K.K., and the bonding strength at room temperature was thus obtained. The room-temperature bonding strength can be said to be good bonding strength when it is 20 MPa or more.

### (260° C. Bonding Strength)

A silver-plated copper lead frame of 10 mm×10 mm was coated with the electrically conductive adhesive composition obtained and after placing a silver-sputtered silicon chip of 2 mm×2 mm on the coated surface, heated at 250° C. for 60 minutes in a nitrogen atmosphere to prepare a bonded body in which the silver-plated copper lead frame and the silver-sputtered silicon chip are bonded via a cured electrically conductive adhesive (hereinafter, sometimes simply referred to as “bonded body”). The resulting bonded body was subjected to a breaking test by heating the stage at 260° C. and using Bond Tester 4000 manufactured by Nordson Advance Technology K.K., and the bonding strength at 260° C. was thus obtained. The 260° C. bonding strength can be said to be good bonding strength when it is 10 MPa or more.

| | | Example | | | | | | | |
|---|---|---|---|---|---|---|---|---|---|
| | | 1 | 7 | 3 | 4 | 5 | 6 | 7 | 8 |
| Organic acid (A) | Abietic acid | 0.050 | 0.01O | 0.030 | 0.100 | — | — | 0.049 | 0.046 |
| | Sebacic acid | — | — | — | — | 0.050 | — | — | — |
| | Ascorbic acid | — | — | — | — | — | 0.050 | — | — |
| Other organic acids | Stearic acid | — | — | — | — | — | — | — | — |
| Electrically | Silver particle 1 | 27.47 | 27.47 | 27.47 | 27.47 | 27.47 | 27.47 | 27.62 | 27.52 |
| conductive | Silver particle 2 | 36.63 | 36.63 | 36.63 | 36.63 | 36.63 | 36.63 | 36.83 | 36.70 |
| filler (B) | Silver particle 3 | 27.47 | 27.47 | 27.47 | 27.47 | 27.47 | 27.47 | 27.62 | 27.52 |
| | Silver-coated copper particle | * | — | — | — | — | — | — | — |
| | [B] | 91.57 | 91.57 | 91.57 | 91.57 | 91.57 | 91.57 | 92.08 | 91.74 |
| Binder resin (C1) | Binder resin 1 | 0.42 | 0.42 | 0.42 | 0.42 | 0.42 | 0.42 | 0.14 | 0.00 |
| Diluent (C2) | Binder resin 2 | 0.85 | 0.85 | 0.85 | 0.85 | 0.85 | 0.85 | 0.28 | 0.00 |
| Curing agent (C3) | Binder resin 3 | 0.14 | 0.14 | 0.14 | 0.14 | 0.14 | 0.14 | 0.05 | 0.00 |
| Curing accelerator (C4) | Diluent | 0.85 | 0.85 | 0.85 | 0.85 | 0.85 | 0.85 | 0.28 | 0.00 |
| | Curing agent | 0.42 | 0.42 | 0.42 | 0.42 | 0.42 | 0.42 | 0.14 | 0.00 |
| | Curing accelerator | 0.14 | 0.14 | 0.14 | 0.14 | 0.14 | 0.14 | 0.05 | 0.00 |
| | [C] | 2.82 | 2.82 | 2.82 | 2.82 | 2.82 | 2.82 | 0.93 | 0.00 |

| | | | | | | | | |
|---|---|---|---|---|---|---|---|---|
| Solvent | 5.560 | 5.600 | 5.586 | 5.510 | 5.560 | 5.560 | 6.949 | 8.211 |
| [B]/[C] | 97/3 | 97/3 | 97/3 | 97/3 | 97/3 | 97/3 | 99/1 | 100/b |
| Thermal conductivity (W/m · k) | 150 | 150 | 155 | 140 | 150 | 150 | 200 | 230 |
| Peeled area (%) | 5 | 5 | 5 | 4 | 7 | 5 | 9 | 15 |
| Room-temperature bonding strength (MPa) | 50 | 50 | 50 | 50 | 50 | 50 | 50 | 50 |
| 260° C. Bonding strength 13 MPa) | 30 | 30 | 30 | 30 | 30 | 30 | 35 | 40 |

| | |
|---|---|
| Example | Comparative Example |

| | | 9 | 10 | 11 | 12 | 1 | 2 | 3 | 4 |
|---|---|---|---|---|---|---|---|---|---|
| Organic acid (A) | Abietic acid | 0.047 | 0.047 | 0.047 | 9.010 | — | — | 0.005 | 0.300 |
| | Sebacic acid | — | — | — | — | — | — | — | — |
| | Ascorbic acid | — | — | * | * | * | — | — | — |
| Other organic acids | Stearic acid | * | — | — | — | — | 0.050 | — | — |
| Electrically | Silver particle 1 | 27.59 | 27.59 | 27.59 | — | 27.47 | 27.47 | 27.47 | 27.47 |
| conductive | Silver particle 2 | 36.79 | 36.79 | 36.19 | 36.63 | 36.63 | 36.63 | 36.63 | 36.63 |
| filler (B) | Silver particle 3 | 27.59 | 27.59 | 27.59 | 27.47 | 27.47 | 27.47 | 27.47 | 27.47 |
| | Silver-coated copper particle | — | — | — | 27.47 | — | — | — | — |
| | [B] | 91.98 | 91.98 | 91.98 | 91.57 | 91.57 | 91.57 | 91.57 | 91.57 |
| Binder resin (C1) | Binder resin 1 | 0.28 | 0.2S | 0.28 | 0.42 | 0.42 | 0.42 | 0.42 | 0.42 |
| Diluent (C2) | Binder resin 2 | 0.57 | 0.57 | 0.57 | 0.85 | 0.85 | 0.85 | 0.85 | 0.85 |
| Curing agent (C3) | Binder resin 3 | 0.09 | 0.09 | 0.09 | 0.14 | 0.14 | 0.14 | 0.14 | 0.14 |
| Caring accelerator (C4) | Diluent | 3.57 | 0.57 | 5.07 | 0.85 | 0.85 | 0.85 | 0.85 | 0.85 |
| | Curing agent | 0.28 | 0.28 | 0.28 | 0.42 | 0.42 | 0.42 | 0.42 | 0.42 |
| | Curing accelerator | 0.09 | 0.09 | 0.09 | 0.14 | 0.14 | 0.14 | 0.14 | 0.14 |
| | [C] | 4.88 | 1.88 | 6.38 | 2.82 | 2.82 | 2.82 | 2.82 | 2.82 |

| | | | | | | | | |
|---|---|---|---|---|---|---|---|---|
| Solvent | 3.100 | 6.100 | 1.600 | 5.606 | 5.610 | 5.560 | 5.605 | 5.310 |
| [B]/[C] | 95/5 | 98/2 | 93/7 | 97/3 | 97/3 | 97/3 | 97/3 | 97/3 |
| Thermal conductivity (W/m · k) | 120 | 180 | 90 | 130 | 140 | 140 | 150 | 90 |
| Peeled area (%) | 10 | 8 | 14 | 12 | 38 | 41 | 37 | 32 |
| Room-temperature bonding strength (MPa) | 45 | 50 | 40 | 45 | 50 | 50 | 50 | 40 |
| 260° C. Bonding strength MPa) | 18 | 32 | 15 | 22 | 30 | 30 | 30 | 20 |

As shown in Table 1, in the bonded bodies obtained using the electrically conductive adhesive compositions of Examples 1 to 12, the peeled area after the thermal cycle test was small, compared with the bonded bodies obtained using the electrically conductive adhesive compositions of Comparative Examples 1 to 4.

From these results, it could be confirmed that according to the electrically conductive adhesive composition of the present invention, adhesion not allowing easy separation of the adherend material even when subjected to repeated temperature change and ensuring excellent thermal conductivity can be achieved.

While the invention has been described in detail and with reference to specific embodiments thereof, it will be apparent to one skilled in the art that various changes and modifications can be made therein without departing from the spirit and scope thereof. This application is based on a Japanese patent application filed on Jan. 23, 2018 (Patent Application No. 2018-009115), the entirety of which is incorporated herein by way of reference. All references cited herein are incorporated by reference herein in their entirety.

1. An electrically conductive adhesive composition comprising an organic acid (A) and an electrically conductive filler (B), wherein
the electrically conductive adhesive composition contains from 0.01 to 0.2 mass % of the organic acid (A) and 85 mass % or more of the electrically conductive filler (B), relative to the overall amount of the electrically conductive adhesive composition, and
the organic acid (A) has an acid dissociation constant pKa of 4.8 or less.

2. The electrically conductive adhesive composition according to claim 1, wherein the organic acid (A) has a molecular weight of 170 or more.

3. The electrically conductive adhesive composition according to claim 1, wherein the organic acid (A) is at least one organic acid selected from the group consisting of abietic acid, pimaric acid, isopimaric acid, palustric acid, dehydroabietic acid, neoabietic acid, sebacic acid, ascorbic acid, and suberic acid.

4. The electrically conductive adhesive composition according to claim 1, wherein the electrically conductive adhesive composition contains a binder resin (C1) and may further contain at least one selected from the group consisting of a diluent (C2), a curing agent (C3), and a curing accelerator (C4), and
denoting [B] mass % as the content of the electrically conductive filler (B) and denoting [C] mass % as the sum of the contents of the binder resin (C1), the diluent (C2), the curing agent (C3) and the curing accelerator (C4), [B]/[C] is 95/5 or more.

5. A cured electrically conductive adhesive obtained by curing the electrically conductive adhesive composition according to claim 1.

6. An electronic device in which the electrically conductive adhesive composition according to claim 1 is used for the adhesion of a component.
